(19) United States
(12) Patent Application Publication
(10) Pub. No.: US 2022/0009412 A1
(43) Pub. Date: Jan. 13, 2022

(54) Apparatus and Method for Warning of an Oncoming Vehicle

(71) Applicant: ARRIVAL LIMITED, London Greater London (GB)

(72) Inventor: Islam Babaev, Saint-Petersburg (RU)

(21) Appl. No.: 17/296,082

(22) PCT Filed: Nov. 20, 2019
(86) PCT No.: PCT/EP2019/081998

§ 371 Date: May 21, 2021

(30) Foreign Application Priority Data
Nov. 21, 2018 (RU) 2018141001

(51) Int. Cl. B60Q 1/52; G08G 1/16; G06K 9/00; G06K 9/46

(52) U.S. Cl. CPC B60Q 1/525; G08G 1/167; G06K 9/4661; G06K 9/00825; G08G 1/166

(57) ABSTRACT

Apparatus and methods for warning of an oncoming vehicle are disclosed. The apparatus comprises one or more sensors for detecting an oncoming vehicle, and a light emitting unit controllable to signal to a vehicle behind whether an oncoming vehicle has been detected, the light emitting unit being mounted so as to be visible to the vehicle behind. A controller detects an oncoming vehicle in dependence on information received from the one or more sensors, and controls the light emitting unit in dependence on whether an oncoming vehicle is detected.

### TECHNICAL FIELD

The present invention relates to an apparatus and method for warning of an oncoming vehicle.

### BACKGROUND

When vehicles on the same road are travelling at different speeds, drivers may attempt to overtake slower-moving vehicles in front of them. There may be a risk of a collision if a driver attempts to overtake while there is an oncoming vehicle travelling in the opposite direction. However, in some circumstances the overtaking driver may not be able to see the oncoming vehicle before deciding whether to change lane and begin an overtaking manoeuvre, particularly when the slower-moving vehicle being overtaken is a large vehicle such as a truck or bus. Once the driver has changed lanes it may no longer be possible to return to the original lane, for example if the road is overcrowded and another vehicle has moved forward into the space previously occupied by the overtaking vehicle.

To address this problem, a system has been proposed in which a video screen is mounted on the rear of a vehicle, and video captured by a camera at the front of the vehicle is streamed directly to the video screen to allow drivers behind the vehicle to see oncoming vehicles that would otherwise be obscured from view. However, such systems are costly and complex, and could prove distracting to other road users.

The invention is made in this context.

### SUMMARY OF THE INVENTION

According to the present invention, there is provided a vehicle-mounted system for warning of an oncoming vehicle, the system comprising one or more sensors for detecting an oncoming vehicle, a light emitting unit controllable to signal to a vehicle behind whether an oncoming vehicle has been detected, the light emitting unit being disposed so as to be visible to the vehicle behind, and a controller configured to detect an oncoming vehicle in dependence on information received from the one or more sensors, and control the light emitting unit in dependence on whether an oncoming vehicle is detected.

In some embodiments according to the first aspect, the light emitting unit is controllable to selectively emit light of a first wavelength to signal to the vehicle behind whether an oncoming vehicle has been detected, and the controller is configured to control the light emitting unit to emit light of the first wavelength in dependence on whether an oncoming vehicle is detected.

In some embodiments according to the first aspect, the light emitting unit is further controllable to emit light of a second wavelength, and the controller is configured to control the light emitting unit to emit light of the first wavelength in response to an to oncoming vehicle being detected, and to emit light of the second wavelength in response to no oncoming vehicle being detected.

In some embodiments according to the first aspect, the light emitting unit is further controllable to emit light of a third wavelength, wherein the controller is configured to determine a probability that the information received from the one or more sensors is indicative of the presence of an oncoming vehicle, and to determine that an oncoming vehicle is detected in response to the probability being higher than a first threshold or to determine that an oncoming vehicle is not detected in response to the probability being lower than a second threshold, the first threshold being higher than the second threshold, and wherein the controller is configured to control the light emitting unit to emit light of the third wavelength in response to the probability being between the first and second thresholds.

In some embodiments according to the first aspect, the light emitting unit is further controllable to emit light of a fourth wavelength, and the controller is configured to control the light emitting unit to emit light of the fourth wavelength in response to a system error occurring.

In some embodiments according to the first aspect, the light emitting unit comprises a display and the controller is configured to control the display to indicate whether an oncoming vehicle is detected.

In some embodiments according to the first aspect, the controller is configured to control the light emitting unit to display a first indication in response to an oncoming vehicle being detected, and to display a second indication in response to no oncoming vehicle being detected.

In some embodiments according to the first aspect, the controller is configured to control the light emitting unit to display a first indication in response to an oncoming vehicle being detected, and to cease to display the first indication in response to no oncoming vehicle being detected.

In some embodiments according to the first aspect, the controller is configured to control the light emitting unit to display a second indication in response to no oncoming vehicle being detected, and to cease to display the second indication in response to an oncoming vehicle being detected.

In some embodiments according to the first aspect, the controller is configured to determine a probability that the information received from the one or more sensors is indicative of the presence of an oncoming vehicle, and to determine that an oncoming vehicle is detected in response to the probability being higher than a first threshold or to determine that an oncoming vehicle is not detected in response to the probability being lower than a second threshold, the first threshold being higher than the second threshold, wherein the controller is configured to control the light emitting unit to display a third indication in response to the probability being between the first and second thresholds.

In some embodiments according to the first aspect, the controller is configured to control the light emitting unit to display a fourth indication in response to a system error occurring.

In some embodiments according to the first aspect, the light emitting unit comprises one or more light emitting diodes.

In some embodiments according to the first aspect, the one or more sensors comprise a front-facing camera and/or a lidar system.

In some embodiments according to the first aspect, the controller is configured to detect an oncoming vehicle by applying a shape recognition algorithm to an image captured by the front-facing camera.

In some embodiments according to the first aspect, the controller is configured to detect an oncoming vehicle by searching for a light source indicative of a vehicle headlight in an image captured by the front-facing camera.

In some embodiments according to the first aspect, the vehicle-mounted system is included in a first vehicle, and wherein the controller is configured to detect an oncoming vehicle in dependence on a wavelength of light emitted by, and/or an indication displayed by, a corresponding light emitting unit on a second vehicle ahead of the first vehicle.

In some embodiments according to the first aspect, the vehicle-mounted system further comprises a manual override mechanism which, when activated by an occupant of a vehicle in which the system is included, is configured to control the light emitting unit to signal to the vehicle behind that there is an oncoming vehicle, irrespective of any signals sent from the controller to the light emitting unit.

In some embodiments according to the first aspect, the manual override mechanism comprises a push button, and is configured to be activated when said button is depressed for at least a minimum length of time.

According to a second aspect of the present invention, there is provided a vehicle comprising the apparatus according to the first aspect.

In some embodiments according to the second aspect, the light emitting unit is mounted on a rear face of the vehicle.

In some embodiments according to the second aspect, the light emitting unit is configured to indicate a destination of the vehicle.

According to a third aspect of the present invention, there is provided a method for reducing a risk of a collision between vehicles when overtaking, the method comprising: detecting an oncoming vehicle in dependence on information received from one or more sensors; and in dependence on whether an oncoming vehicle is detected, controlling a light emitting unit to signal to a vehicle behind whether an oncoming vehicle has been detected, the light emitting unit being disposed so as to be visible to the vehicle behind.

In some embodiments according to the third aspect, the controlling comprises controlling the light emitting unit to emit light of a first wavelength to signal to the vehicle behind whether an oncoming vehicle has been detected.

According to a fourth aspect of the present invention, there is provided a computer program product comprising software instructions which, when executed, cause performance of a method according to the third aspect.

to According to a fifth aspect of the present invention, there is provided a computer-readable storage medium storing a computer program product according to the fourth aspect.

In some embodiments according to the fifth aspect, the storage medium is a non-transitory storage medium.

### BRIEF DESCRIPTION OF THE DRAWINGS

Embodiments of the present invention will now be described, by way of example only, with reference to the accompanying drawings, in which:

FIG. 1 illustrates a vehicle configured to signal to a vehicle behind whether there is an oncoming vehicle approaching, according to an embodiment of the present invention;

FIG. 2 illustrates apparatus for detecting an oncoming vehicle and signalling to a vehicle behind whether an oncoming vehicle has been detected, according to an embodiment of the present invention;

FIG. 3 illustrates a mechanism for deactivating the apparatus for detecting an oncoming vehicle, according to an embodiment of the present invention;

FIG. 4 is a flowchart showing a method of controlling a light emitting unit to signal whether an oncoming vehicle has been detected, according to an embodiment of the present invention;

FIG. 5A is a flowchart showing a method of controlling a light emitting unit capable of emitting a plurality of different colours of light, according to an embodiment of the present invention;

FIG. 5B is a flowchart showing a method of controlling a light emitting unit capable of displaying messages, according to an embodiment of the present invention;

FIG. 6 illustrates a vehicle configured to signal to a vehicle behind whether there is an oncoming vehicle approaching is illustrated, according to an embodiment of the present invention; and

FIG. 7 illustrates a manual override mechanism for overriding the automatic warning system, according to an embodiment of the present invention.

### DETAILED DESCRIPTION

In the following detailed description, only certain exemplary embodiments of the present invention have been shown and described, simply by way of illustration. As those skilled in the art would realise, the described embodiments may be modified in various different ways, all without departing from the scope of the present invention. Accordingly, the drawings and description are to be regarded as illustrative in nature and not restrictive. Like reference numerals designate like elements throughout the specification.

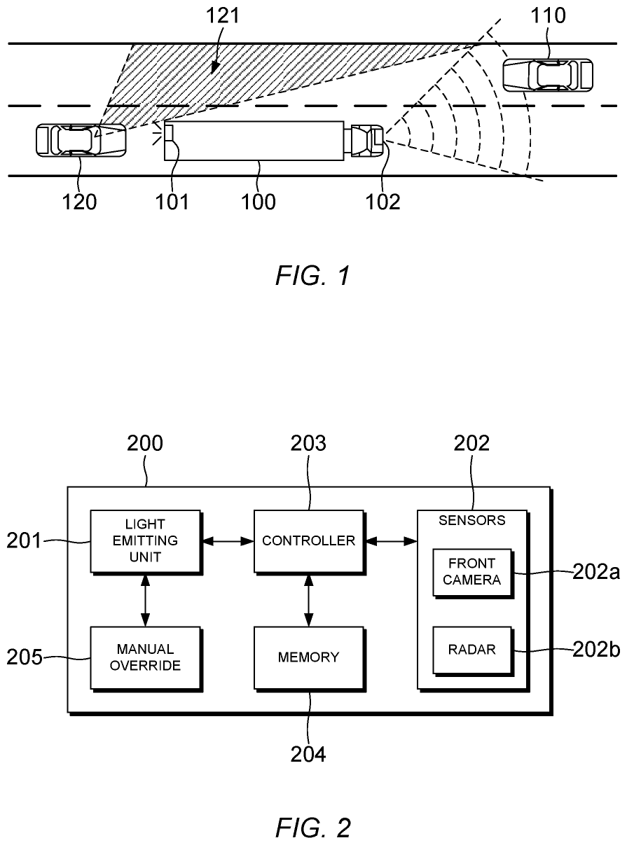

Referring now to FIG. 1, a vehicle configured to signal to a vehicle behind whether there is an oncoming vehicle approaching is illustrated, according to an embodiment of the present invention. The vehicle 100 comprises a light emitting unit 101 that is controllable to selectively emit light of a first wavelength, for example red light. The light emitting unit 101 may comprise any suitable type of device for emitting light, such as one or more light emitting diode (LEDs) or a halogen bulb.

The light emitting unit 101 is disposed on the vehicle 100 so as to be visible to the vehicle 120 behind, that is, a vehicle 120 that is following behind the vehicle 100 in which the light emitting unit 101 is mounted. In the present embodiment, the light emitting unit 101 is mounted on a rear face of the vehicle 100. For example, in one embodiment the light emitting unit 101 may be integrated into a rear light cluster of the vehicle 100, comprising other lights such as a braking light, reversing light, and/or a rear turn signal light. In another embodiment the light emitting unit 101 may be mounted in a different location to the rear light cluster, to help the driver of the vehicle behind 120 to easily distinguish the light emitting unit 101 from other rear-mounted lights of the vehicle 100.

The vehicle 100 further comprises one or more sensors 102 for detecting an oncoming vehicle 110. For example, the one or more sensors 102 may comprise a front-facing camera and/or a lidar system. The light emitting unit 101 can be controlled to emit light in dependence on whether an oncoming vehicle 110 has been detected. In the situation illustrated in FIG. 1, the oncoming vehicle 110 is within range of the one or more sensors 102, but is outside of a field of view 121 of the driver of the vehicle behind 120. For example, in the scenario illustrated in FIG. 1 the oncoming vehicle 110 is obscured by the vehicle 100, and so is not currently visible to the driver of the vehicle behind 120. In another scenario, the oncoming vehicle 110 may not be visible to the driver of the vehicle behind 120 due to a bend in the road, or due to elevation changes on the road between the oncoming vehicle 110 and the vehicle behind 120, but may still be capable of being detected by the one or more sensors 102 on the middle vehicle 100. In the present embodiment, a controller in the vehicle 100 which comprises the light emitting unit 101 is configured to detect an oncoming vehicle in dependence on information received from the one or more sensors 102, and to control the light emitting unit 101 to emit red light if the oncoming vehicle 110 is detected.

By controlling the light emitting unit 101 in dependence on whether an oncoming vehicle 110 has been detected, the vehicle 100 can signal to the driver (or ‘operator’) of the vehicle behind 120 whether or not there is an oncoming vehicle 110 approaching, before the oncoming vehicle 120 may be visible to the driver. The light emitting unit can therefore act to warn the driver of a vehicle 120 behind the current vehicle 100 when an oncoming vehicle 110 is approaching, so that the driver knows not to begin an overtaking manoeuvre.

In the present embodiment the light emitting unit 101 comprises one or more red LEDs and one or more green LEDs, and is therefore controllable to selectively emit red or green light. In response to an oncoming vehicle 110 being detected the light emitting unit 101 is controlled to emit red light, and in response to no oncoming vehicle being detected the light emitting unit 101 is controlled to emit green light. However, in some embodiments the light emitting unit 101 may only be capable of emitting a single colour of light, and can be turned on or off to signal whether or not an oncoming vehicle is detected.

For example, in one embodiment the light emitting unit 101 may only be capable of emitting red light, and can be turned on when an oncoming vehicle is detected and turned off when an oncoming vehicle is not detected. Alternatively, in another embodiment the light emitting unit 101 may only be capable of emitting green light, and can be turned off when an oncoming vehicle is detected and turned on when an oncoming vehicle is not detected. It will be appreciated that red and green colours of light are described here by way of example only, and in other embodiments different colours of light may be chosen to indicate the presence or absence of an oncoming vehicle.

Referring now to FIG. 2, apparatus for detecting an oncoming vehicle and signalling to a vehicle behind whether an oncoming vehicle has been detected is illustrated, according to an embodiment of the present invention. The apparatus may be included in the vehicle 100 described above with reference to FIG. 1. The apparatus 200 comprises the light emitting unit 201 and one or more sensors 202. In the present embodiment, the apparatus 200 comprises two sensors, in the form of a front-facing camera 202a and a front-facing light detection and ranging (lidar) system 202b. It will be appreciated that a camera and lidar sensor are described here by way of example only, and in other embodiments different types of sensors may be used.

The apparatus further comprises a controller 203 configured to receive signals from the one or more sensors 202, and detect an oncoming vehicle 110 in dependence on information included in the received signals. For example, the controller 203 may receive an image captured by the front-facing camera 202a, and apply a shape recognition algorithm to the image to determine whether the image contains an oncoming vehicle 110. The shape recognition algorithm may, for example, be a machine learning algorithm configured to detect a silhouette of a car, van, truck or other type of vehicle in an image. In some embodiments, the controller 203 may be configured to detect an oncoming vehicle 110 by searching for a light source indicative of a vehicle headlight in the image captured by the front-facing camera 202a.

In some embodiments the controller 203 may be configured to use data from a plurality of sensors 202 to determine whether there is an oncoming vehicle no. For example, the controller 203 may derive one or more recognition metrics such as recall, accuracy, or precision, for each one of a plurality of sensor signals. The controller 203 may then take a decision based on the plurality of metrics obtained from the plurality of sensor signals. The controller 203 may apply different weightings to the metrics derived from different types of sensor according to their reliability under current conditions. For example, in conditions of mist or fog, metrics derived from a camera which is capable of detecting fog lights of an oncoming vehicle 110 may be given a higher weighting than metrics derived from a lidar sensor, which may be less reliable than the camera under foggy or misty conditions. In some embodiments, the controller 203 may use a sensor fusion method to combine data from a plurality of sensors 202 before deriving one or more metrics from the combined data.

In the present embodiment, the controller 203 comprises one or more processors capable of executing software instructions, and the apparatus further comprises a memory 204. The memory 204 can comprise any suitable form of non-transitory storage medium capable of storing software instructions, and is arranged to store a computer program product comprising software instructions which, when executed by to the one or more processors in the controller 203, cause the controller 203 to perform any of the methods disclosed herein. However, although the controller functions are implemented in software in the present embodiment, it will be appreciated that in other embodiments a hardware implementation may be used. For example, in some embodiments the controller 203 may be embodied as an application-specific integrated circuit (ASIC) or field-programmable gate array (FPGA).

Continuing with reference to FIG. 2, in the present embodiment the controller 203 is configured to generate a control signal indicative of one of the following logical states: “state=1” if the controller 203 determines that a probability of there being an oncoming vehicle 110 is higher than a first threshold, based on the result of processing information from the one or more sensors 202; “state=0” if the controller 203 determines that a probability of there being an oncoming vehicle 110 is lower than a second threshold, the second threshold being lower than the first threshold; “state=undef” if the probability of there being an oncoming vehicle 110 is between the first and second thresholds; and “state=err” if a software or hardware error has occurred. The control signal indicative of the “state” variable is then sent to the light emitting unit 201, for example via a chassis area network (CAN), a controller area network or any other suitable communication interface. The light emitting unit 201 is configured to selectively emit light in accordance with the value of the “state” variable received from the controller 203.

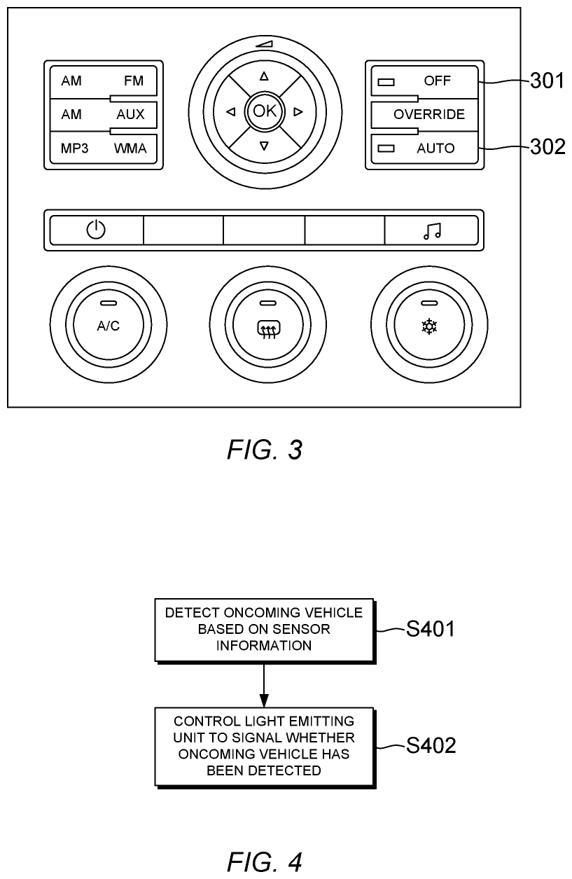

In some embodiments, the apparatus 200 may further comprise a mechanism for deactivating the light emitting unit 201. An example of a mechanism 205 for deactivating the light emitting unit 201 is illustrated in FIG. 3, according to an embodiment of the present invention. The mechanism 205 can be activated by an occupant of the vehicle loo, for example the driver or a passenger, to deactivate the light emitting unit 201 and/or the other components of the apparatus 200. This allows the occupant of the vehicle 100 to manually deactivate the automatic warning system, for example in conditions where the system is not able to reliably detect the presence of an oncoming vehicle 110.

In the present embodiment the mechanism 205 for deactivating the light emitting unit 201 and/or the other components of the apparatus 200 comprises first and second push button switches 301, 302. The first switch 301 can be pressed to deactivate the light emitting unit 201 and/or the other components of the apparatus 200. The second switch 302 can be pressed to set the apparatus 200 into the usual operating mode, referred to herein as an “automatic detection” or “auto” mode, in which the controller 203 automatically controls the operation of the light emitting unit 201 without the need for human intervention. The mechanism can be configured such that only one of the first and second switches 301, 302 can be depressed at any time. That is, activating one of the switches 301, 302 can automatically reverse the state of the other switch 301, 302, to prevent both switches 301, 302 being activated at the same time.

Referring now to FIG. 4, a flowchart showing a method of controlling a light emitting unit to signal whether an oncoming vehicle has been detected is illustrated, according to an embodiment of the present invention. The method may, for example, be implemented by software instructions stored in the memory 204 of the apparatus 200 illustrated in FIG. 2.

First, in step S401 the controller 203 attempts to detect an oncoming vehicle in dependence on information received from the one or more sensors 202, such as a front-facing camera 202a or lidar 202b as described above. Then, in step S402 the controller 203 controls the light emitting unit 201 to signal to a vehicle behind whether an oncoming vehicle has been detected. For example, if an oncoming vehicle 110 was detected in step S401 the controller 203 may control the light emitting unit 201 to emit red light in step S402, and/or if an oncoming vehicle 110 was not detected in step S401 the controller 203 may control the light emitting unit 201 to emit green light in step S402. As another example, if an oncoming vehicle 110 was detected in step S401 the controller 203 may control the light emitting unit 201 to indicate that an oncoming vehicle was detected and/or that it is not safe to pass in step S402, and/or if an oncoming vehicle 110 was not detected in step S401 the controller 203 may control the light emitting unit 201 to indicate that an oncoming vehicle was not detected and/or that it is safe to pass in step S402.

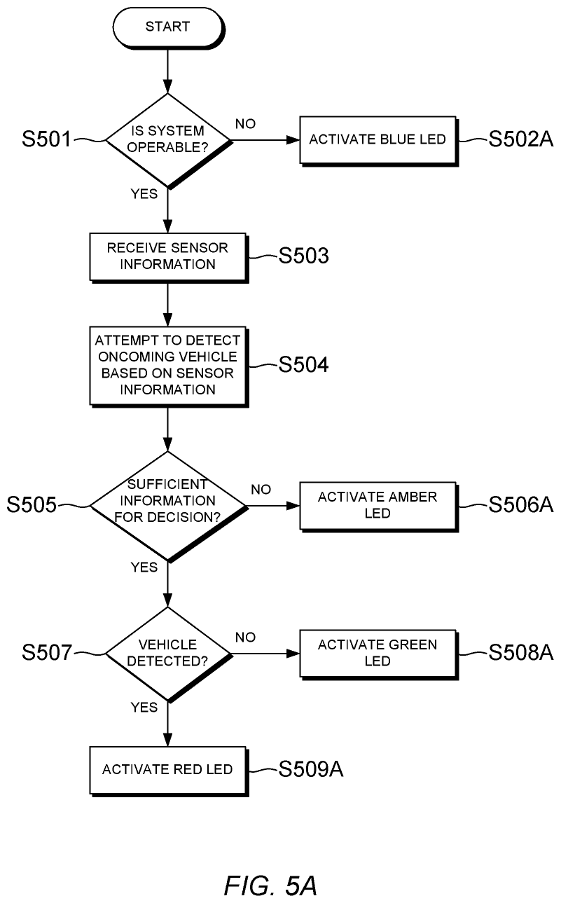

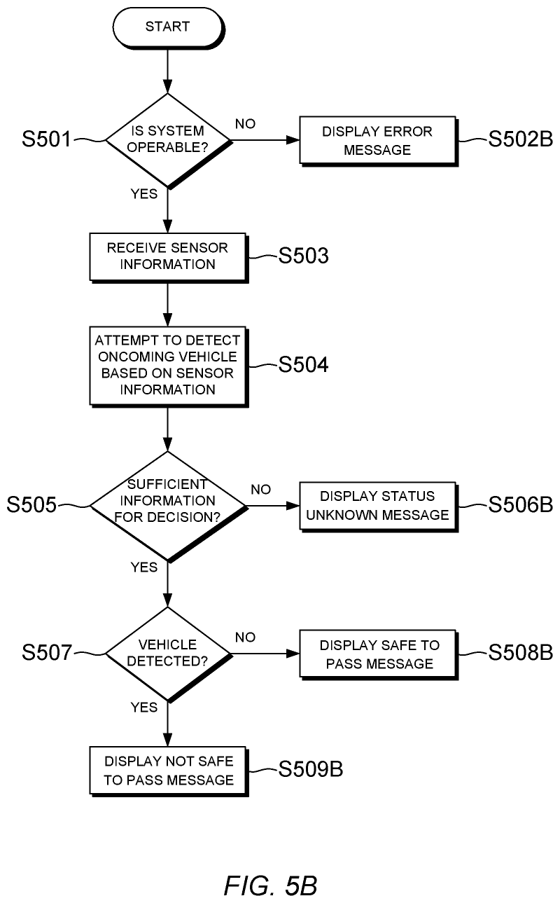

Referring now to FIG. 5A, a flowchart showing a method of controlling a light emitting unit capable of emitting a plurality of different colours of light is illustrated, according to an embodiment of the present invention. In the present embodiment the light emitting unit comprises red, green, blue and amber LEDs, and so is capable of selectively emitting red, green, blue or amber light. However, it will be appreciated that these colours are described by way of example only, and in other embodiments different colours may be chosen to signify the different outcomes described below.

First, in step S501 it is checked whether the system is currently operable. By ‘operable’, it is meant that the automatic warning system is functioning correctly and is capable of detecting oncoming vehicles. If the “state” control signal sent by the controller 203 has the value “state=err”, then in step S501 the light emitting unit 201 can determine that a system error has occurred and consequently the system is not currently operable, and the blue LED is activated in step S502A.

On the other hand, if it is determined in step S501 that the system is currently operable, then the process continues to step S503. Here, the controller 203 receives sensor information from the one or more sensors 202. Then, in step S504 the controller 203 attempts to detect an oncoming vehicle based on the received sensor information. In the present embodiment the controller 203 is configured to calculate a probability that the received sensor information is indicative of the presence of an oncoming vehicle 110. However, in other embodiments a different approach may be used, for example in step S504 the controller may reach a simple yes/no decision as to whether an oncoming vehicle 110 is present.

In step S505, the controller 203 determines whether there was sufficient information to reach a decision as to whether an oncoming vehicle is present. In the present embodiment, in step S505 the controller 203 determines that insufficient information was available for a reliable detection to be made if the probability is between the first and second thresholds, as described above (“state=undef”), and in response the amber LED is activated in step S506A.

If a reliable detection was possible, then the process proceeds to step S507 and activates either the red or green LEDs according to whether or not a vehicle was detected in step S504. In the present embodiment, if the probability is below the second threshold (“state=0”) then it is determined in step S507 that an oncoming vehicle was not detected, and in step S508A the green LED is activated. On the other hand, if the probability is higher than the first threshold (“state=1”) then it is determined in step S507 that an oncoming vehicle was detected, and in step S509A the red LED is activated.

In some embodiments, the light emitting unit 201 comprises a display, which may comprise one or more LEDs, and which may also be configured to indicate a destination of the vehicle loo and may be mounted on a rear face of the vehicle loo. The controller 203 is configured to control the display to indicate whether an oncoming vehicle is detected. The controller 203 may be configured to control the light emitting unit 201 to display a first indication in response to an oncoming vehicle 110 being detected, and to display a second, different indication in response to no incoming vehicle being detected. As a result, the driver or operator of the vehicle behind 120 may be continuously aware of whether or not an oncoming vehicle 110 is detected. As an alternative, the controller 203 may be configured to control the light emitting unit 201 to display a first indication in response to an oncoming vehicle 110 being detected, and to cease to display the first indication in response to no oncoming vehicle being detected. As a result, the driver or operator of the vehicle behind 120 may only be notified of an oncoming vehicle when such a vehicle is detected and when it is therefore not likely to be safe to perform a passing manoeuvre. As yet another alternative, the controller may be configured to control the light emitting unit to display a second indication in response to no oncoming vehicle being detected, and to cease to display the second indication in response to an oncoming vehicle 110 being detected. As a result, the driver or operator of the vehicle behind 120 may only be notified when no oncoming vehicle is detected and when it is therefore likely to be safe to perform a passing manoeuvre.

The controller 203 may also be configured to control the light emitting unit 201 to display a third indication in response to the probability that the received sensor information is indicative of the presence of an oncoming vehicle 110 being between the first and second thresholds. The controller 203 may also be configured to control the light emitting unit 201 to display a fourth indication in response to a system error occurring.

Each of the first, second, third and/or fourth indications may be a different (or ‘distinct’) message, string of characters, symbol, graphic/image, and/or barcode (linear/one-dimensional, or two-dimensional). The first, second, third and fourth indications respectively indicate:
that an oncoming vehicle has been detected or that it is not safe to pass the vehicle too,
that no oncoming vehicle has been detected or that is safe to pass the vehicle too,
that an oncoming vehicle may have been detected or that it may be safe (or may not be safe) to pass the vehicle too, and
that it is currently not possible to detect oncoming vehicles or that it is currently not possible to determine whether it is safe to pass the vehicle too.

The first, second, third and fourth indications may respectively be referred to as a ‘not safe to pass’ message, a ‘safe to pass’ message, a ‘status unknown’ message, and a ‘system error’ message.

Referring now to FIG. 5B, a flowchart showing a method of controlling a light emitting unit capable of displaying messages is illustrated, according to an embodiment of the present invention. In the present embodiment the light emitting unit is capable of selectively displaying messages. However, it will be appreciated that these messages are described by way of example only, and in other embodiments different messages—or indeed even other indications, as outlined above—may be chosen to signify the different outcomes described below.

First, in step S501 it is checked whether the system is currently operable, as in FIG. 5A. If the “state” control signal sent by the controller 203 has the value “state=err”, then in step S501 the light emitting unit 201 can determine that a system error has occurred and consequently the system is not currently operable, and a ‘system error’ message is displayed in step S502B.

On the other hand, if it is determined in step S501 that the system is currently operable, then the process continues to step S503. Here, the controller 203 receives sensor information from the one or more sensors 202. Then, in step S504 the controller 203 attempts to detect an oncoming vehicle based on the received sensor information. In the present embodiment the controller 203 is configured to calculate a probability that the received sensor information is indicative of the presence of an oncoming vehicle 110. However, in other embodiments a different approach may be used, for example in step S504 the controller may reach a simple yes/no decision as to whether an oncoming vehicle 110 is present.

In step S505, the controller 203 determines whether there was sufficient information to reach a decision as to whether an oncoming vehicle is present. In the present embodiment, in step S505 the controller 203 determines that insufficient information was available for a reliable detection to be made if the probability is between the first and second thresholds, as described above (“state=undef”), and in response a ‘status unknown’ message is displayed in step S506B.

If a reliable detection was possible, then the process proceeds to step S507 and displays either a ‘safe to pass’ or ‘not safe to pass’ message according to whether or not a vehicle was detected in step S504. In the present embodiment, if the probability is below the second threshold (“state=0”) then it is determined in step S507 that an oncoming vehicle was not detected, and in step S5o8B the ‘safe to pass’ message is displayed. On the other hand, if the probability is higher than the first threshold (“state=1”) then it is determined in step S507 that an oncoming vehicle was detected, and in step S509B the ‘not safe to pass’ message is displayed.

In some embodiments, when an oncoming vehicle 110 is detected in step S507, the controller 203 may determine a distance to the oncoming vehicle 110 based on the sensor information, and may only proceed to activate the red LED in step S509A or display the ‘not safe to pass’ message in step S509B when it is determined that the oncoming vehicle 110 is closer than a certain threshold distance. The threshold distance, that is to say the distance which triggers activation of the red LED, may be pre-programmed into the controller 203. In some embodiments the threshold distance may be adjusted taking into account the relative speed of approach of the oncoming vehicle 203 and the vehicle 100 in which the controller is mounted.

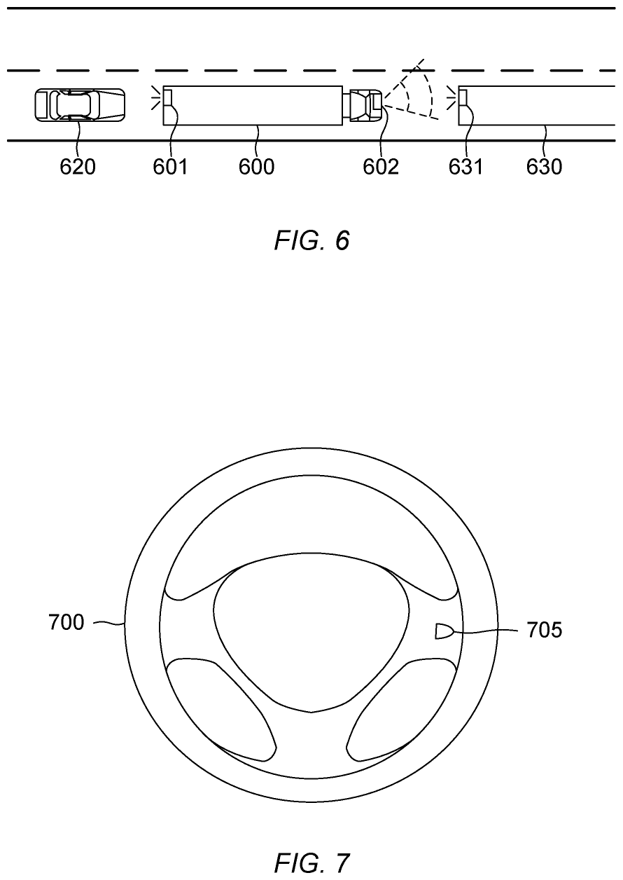

In the embodiments described above, a vehicle 100 detects an oncoming vehicle 110 directly by using one or more sensors 102 mounted on the vehicle 100. However, in other embodiments an oncoming vehicle may be detected indirectly by relying on the illumination state of, or indication displayed by, a corresponding light emitting unit of a vehicle in front of the current vehicle, as illustrated in FIG. 6. In this embodiment, a first vehicle 600 comprises a light emitting unit 601 and one or more sensors 602, and the one or more sensors 602 can be used to determine a wavelength of light emitted by, or an indication displayed by, a corresponding light emitting unit 631 on a second vehicle 630 ahead of the first vehicle 600. For example, the one or more sensors 602 to may be capable of detecting whether the corresponding light emitting unit 631 on the second vehicle 630 is currently emitting red, green, blue or amber light. As another example, the one or more sensors 602 may be capable of detecting whether the corresponding light emitting unit 631 on the second vehicle 6is currently displaying a ‘system error’ message or indication, a ‘status unknown’ message or indication, a ‘safe to pass’ message or indication, or a ‘not safe to pass’ message or indication. Such a detection may be performed, for example, using an optical character recognition technique or other computer vision technique as appropriate to the nature of the indication. A controller included in the first vehicle 6can use the colour of light detected by, or the indication displayed by, the one or more sensors 602 as an indication of whether there is an oncoming vehicle ahead of the second vehicle 630, and control the light emitting unit 601 in the first vehicle 600 accordingly.

Referring now to FIGS. 2 and 7, in some embodiments the apparatus 200 may further comprise a manual override mechanism 205 for overriding the controller 203. An example of a manual override mechanism 205 is illustrated in FIG. 3, according to an embodiment of the present invention. In the present embodiment the manual override mechanism 205 comprises a switch 705 on the steering wheel 700 of the vehicle 100, and is situated in a location where the switch can easily be reached by the driver without removing their hand from the steering wheel 700. The switch 705 can be activated by the driver to control the light emitting unit 201 to signal to the vehicle behind 120 that there is an oncoming vehicle 110, irrespective of the value of the “state” variable received from the controller 203. This allows the driver to manually override the automatic warning system, for example in a situation where there is an oncoming vehicle no but the system has not been able to reliably detect the oncoming vehicle 110 (“state=undef”) or when a system error has occurred (“state=err”).

In the present embodiment the manual override mechanism 205 comprises a push button switch 705. The mechanism 205 is configured so that the light emitting unit 201 signals to the vehicle behind 120 that there is an oncoming vehicle 110, for example by emitting red light or displaying a ‘not safe to pass’ message or indication, as long as the switch 705 remains depressed. Once the driver releases the switch 705, the automatic warning system returns to the mode in which it was previously operating, for example “auto” or “off”.

In other embodiments, a manual override mechanism may take a different form other to than a push button switch. For example, in another embodiment the manual override mechanism may comprise a touch-sensitive control surface, such as a touchpad or touchscreen. In yet another embodiment, the manual override mechanism may comprise a voice-activated control that is configured to override the automatic warning system in response to the driver speaking a predefined word or phrase.

In some embodiments, the manual override mechanism 205 can be configured so that the manual override mechanism 205 is only activated in response to the switch 705 being pushed and held for at least a minimum length of time. Requiring the switch 705 to be depressed for a certain length of time before activating the manual override mechanism 205 can prevent the manual override mechanism 205 from being accidentally activated, for example if a user accidentally presses the switch 705 momentarily.

The light of different wavelengths emitted in the embodiments of FIG. 5A may be more straightforward to differentiate using a computer-implemented method than the different indications or messages in the embodiments of FIG. 5B. Accordingly, although the light emitting unit 201 displaying different indications has been described above as an alternative to the light emitting unit 201 emitting light of different wavelengths, in some embodiments, the light emitting unit 201 may display different indications and emit light of different wavelengths; in other words, the features of FIGS. 5A and 5B may be combined. As a result, a driver or operator of the vehicle behind 120 may use the different indications, and optionally also the light of different wavelengths, to determine whether an oncoming vehicle 110 has been detected, whilst the vehicle behind 120 may use the light of different wavelengths.

It will be understood that the vehicle behind 120 need not be a motor vehicle and may, in some implementations, be a bicycle, for example. Such a vehicle may be slow to perform an overtaking manoeuvre, and the approach described herein may enable the vehicle behind 120 to avoid performing such a manoeuvre until there is sufficient time to do so. Similarly, the driver of the vehicle behind 120 may be referred to as an ‘operator’ of the vehicle behind 120, for example, in the case of a vehicle behind 120 which is not a motor vehicle. As one example, the operator of the vehicle behind 120 may be a cyclist.

In some implementations, the vehicle mo may be a large vehicle, such as a bus or truck. In this case, the oncoming vehicle may be more likely to be outside of the field of view 121 of the driver of the vehicle behind 120.

Whilst certain embodiments of the invention have been described herein with reference to the drawings, it will be understood that many variations and modifications will be possible without departing from the scope of the invention as defined in the accompanying claims.

1. Apparatus for warning of an oncoming vehicle, the apparatus comprising:
one or more sensors for detecting an oncoming vehicle;
a light emitting unit controllable to signal to a vehicle behind whether an oncoming vehicle has been detected, the light emitting unit being disposed so as to be visible to the vehicle behind; and
a controller configured to detect an oncoming vehicle in dependence on information received from the one or more sensors, and control the light emitting unit in dependence on whether an oncoming vehicle is detected.

2. The apparatus according to claim 1, wherein the light emitting unit is controllable to selectively emit light of a first wavelength to signal to the vehicle behind whether an oncoming vehicle has been detected, and the controller is configured to control the light emitting unit to emit light of the first wavelength in dependence on whether an oncoming vehicle is detected.

3. The apparatus according to claim 2, wherein the light emitting unit is further controllable to emit light of a second wavelength, and
wherein the controller is configured to control the light emitting unit to emit light of the first wavelength in response to an oncoming vehicle being detected, and to emit light of the second wavelength in response to no oncoming vehicle being detected.

4. The apparatus according to claim 2 wherein the light emitting unit is further controllable to emit light of a third wavelength,
wherein the controller is configured to determine a probability that the information received from the one or more sensors is indicative of the presence of an oncoming vehicle, and to determine that an oncoming vehicle is detected in response to the probability being higher than a first threshold or to determine that an oncoming vehicle is not detected in response to the probability being lower than a second threshold, the first threshold being higher than the second threshold, and
wherein the controller is configured to control the light emitting unit to emit light of the third wavelength in response to the probability being between the first and second thresholds.

5. The apparatus according to claim wherein the light emitting unit is further controllable to emit light of a fourth wavelength, and
wherein the controller is configured to control the light emitting unit to emit light of the fourth wavelength in response to a system error occurring.

6. The apparatus according to any proceeding claim 1, wherein the light emitting unit comprises a display and the controller is configured to control the display to indicate whether an oncoming vehicle is detected.

7. The apparatus according to claim 6, wherein the controller is configured to control the light emitting unit to display a first indication in response to an oncoming vehicle being detected, and to display a second indication in response to no oncoming vehicle being detected.

8. The apparatus according to claim 6, wherein the controller is configured to control the light emitting unit to display a first indication in response to an oncoming vehicle being detected, and to cease to display the first indication in response to no oncoming vehicle being detected.

9. The apparatus according to claim 6, wherein the controller is configured to determine a probability that the information received from the one or more sensors is indicative of the presence of an oncoming vehicle, and to determine that an oncoming vehicle is detected in response to the probability being higher than a first threshold or to determine that an oncoming vehicle is not detected in response to the probability being lower than a second threshold, the first threshold being higher than the second threshold,
wherein the controller is configured to control the light emitting unit to display a third indication in response to the probability being between the first and second thresholds.

10. The apparatus according to claim 6, wherein the controller is configured to control the light emitting unit to display a fourth indication in response to a system error occurring.

11. The apparatus according to claim 1, wherein the light emitting unit comprises one or more light emitting diodes.

12. The apparatus according to claim 1, wherein the one or more sensors comprise a front-facing camera and/or a lidar system.

13. The apparatus according to claim 12, wherein the controller is configured to detect an oncoming vehicle by applying a shape recognition algorithm to an image captured by the front-facing camera.

14. The apparatus according to claim 12, wherein the controller is configured to detect an oncoming vehicle by searching for a light source indicative of a vehicle headlight in an image captured by the front-facing camera.

15. The apparatus according to claim 12, wherein the apparatus is included in a first vehicle, and wherein the controller is configured to detect an oncoming vehicle in dependence on a wavelength of light emitted by, and/or an indication displayed by, a corresponding light emitting unit on a second vehicle ahead of the first vehicle.

16. The apparatus according to claim 1, further comprising:
a manual override mechanism which, when activated by an occupant of a vehicle in which the apparatus is included, is configured to control the light emitting unit to signal to the vehicle behind that there is an oncoming vehicle, irrespective of any signals sent from the controller to the light emitting unit, wherein the manual override mechanism a push button, and is configured to be activated when said button is depressed for at least a minimum length of time.

17. (canceled)

18. A vehicle comprising the apparatus according to claim 1, wherein the light emitting unit is mounted on a rear face of the vehicle and is configured to indicate a destination of the vehicle.

19. (canceled)

20. (canceled)

21. A method for warning of an oncoming vehicle, the method comprising:
detecting an oncoming vehicle in dependence on information received from one or more sensors; and
in dependence on whether an oncoming vehicle is detected, controlling a light emitting unit to signal to a vehicle behind whether an oncoming vehicle has been detected, the light emitting unit being disposed so as to be visible to the vehicle behind.

22. The method according to claim 21, wherein the controlling comprises controlling the light emitting unit to emit light of a first wavelength to signal to the vehicle behind whether an oncoming vehicle has been detected.

23. (canceled)

24. A computer-readable storage medium storing a computer program product including computer-executable instructions that, upon execution by a processor, configure a controller to perform a method as claim 21 recites.
